(19) United States
(12) Patent Application Publication
(10) Pub. No.: US 2026/0135035 A1
(43) Pub. Date: May 14, 2026

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Mina AMANO, Tokyo (JP); Toshiki KONDO, Tokyo (JP)

(73) Assignee: TAIYO YUDEN CO., LTD., Tokyo (JP)

(21) Appl. No.: 19/445,640

(22) Filed: Jan. 12, 2026

Related U.S. Application Data
(63) Continuation of application No. PCT/JP2024/025899, filed on Jul. 19, 2024.

(30) Foreign Application Priority Data
Jul. 26, 2023 (JP) 2023-122035

(51) Int. Cl. H01G 4/008; H01G 4/12; H01G 4/232; H01G 4/248; H01G 4/30; H01G 13/00

(52) U.S. Cl. CPC H01G 4/008; H01G 4/232; H01G 4/248; H01G 4/30; H01G 13/006; H01G 4/12

(57) ABSTRACT

A multilayer ceramic electronic component includes an element body and an external electrode. The element body includes a multilayer body in which ceramic layers formed of ceramic and internal electrodes containing a metal as a main component are alternately stacked, and a ceramic protective portion covering a surface of the element body. The external electrode is disposed on the surface of the element body and electrically connected to the internal electrodes. A sulfur concentration C_{S} in the element body satisfies 0.12 ppm≤C_{S}≤14.5 ppm. The sulfur concentration C_{S} is obtained by dividing a sulfur amount obtained by analyzing, through a combustion-infrared absorption method, a gas generated in a process of heating a powdery sample obtained by grinding the element body to 1250° C. by a mass of the powdery sample before heating.

### CROSS-REFERENCE TO RELATED APPLICATIONS

This application is based upon and claims the benefit of priority of the prior International Patent Application No. PCT/JP2024/025899, filed on Jul. 19, 2024, which claims the benefits of priorities of Japanese Patent Application No. 2023-122035 filed on Jul. 26, 2023, the entire contents of each are incorporated herein by reference.

### FIELD

A certain aspect of the present disclosure relates to a multilayer ceramic electronic component and a method of manufacturing the same.

### BACKGROUND

In automobiles and health and medical equipment, multilayer ceramic electronic components, particularly multilayer ceramic capacitors, are used to control voltage and current. In recent years, the demand for multilayer ceramic capacitors has been increasing more and more due to the use of electric motors in automobiles and the increasing demand for health and medical equipment. In automobiles and health and medical equipment, since a failure or malfunction threatens the safety of users, high reliability is required for a multilayer ceramic capacitor used in these.

One of the causes of the reduction in the reliability of the multilayer ceramic capacitor is a structural defect such as a crack generated inside the capacitor. Generally, a multilayer ceramic capacitor is manufactured by printing a paste for an internal electrode on a green sheet including dielectric powder and a binder, stacking and compressing a plurality of green sheets, and then degreasing and firing the green sheets. When structural defects such as delamination and cracks occur due to rapid combustion of the binder or significant shrinkage of the internal electrodes during degreasing and firing, the structural defects serve as an intrusion path for deterioration factors such as moisture, and the reliability is reduced.

As a method for reducing structural defects of a multilayer ceramic capacitor, it has been reported that the catalytic action of nickel, which is an internal electrode material, is suppressed by sulfur to suppress rapid combustion of a binder (for example, see Patent Document 1: Japanese Patent Application Publication No. 2006-24539, Patent Document 2: Japanese Patent Application Publication No. 2014-91862, and Patent Document 3: Japanese Patent Application Publication No. 2017-25400).

Japanese Patent Application Publication No. 2006-24539 discloses that a nickel paste for internal electrodes contains a sulfur-containing organic compound.

Japanese Patent Application Publication No. 2014-91862 and Japanese Patent Application Publication No. 2017-25400 disclose that nickel particles used in a paste for internal electrodes contain sulfur.

In this way, by suppressing the catalytic action of nickel by sulfur, rapid combustion of the binder during degreasing can be suppressed. However, when using an internal electrode paste containing sulfur, it is necessary to take new measures against structural defects caused by gas generated by decomposition or volatilization of sulfur or a compound containing sulfur (see, for example, Japanese Patent Application Publication No. 2017-25400).

Japanese Patent Application Publication No. 2017-25400 discloses that nickel powder is made to generate the gas containing sulfur in a temperature range of 750° C. or higher, which is higher than the degreasing temperature, and an amount of the generated gas and the temperature range are controlled.

### SUMMARY OF THE INVENTION

According to a first aspect of the present disclosure, there is provided a multilayer ceramic electronic component including an element body and an external electrode. The element body includes a multilayer body in which ceramic layers formed of ceramic and internal electrodes containing a metal as a main component are alternately stacked, and a ceramic protective portion covering a surface of the element body. The external electrode is disposed on the surface of the element body and electrically connected to the internal electrodes. A sulfur concentration C_{S} in the element body satisfies 0.12 ppm≤C_{S}≤14.5 ppm. The sulfur concentration C_{S} is obtained by dividing a sulfur amount obtained by analyzing, through a combustion-infrared absorption method, a gas generated in a process of heating a powdery sample obtained by grinding the element body to 1250° C. by a mass of the powdery sample before heating.

According to a second aspect of the present disclosure, there is provided a method of manufacturing a multilayer ceramic electronic component according to the first aspect of the present disclosure. The method includes: (A) preparing a ceramic powder; (B) mixing the ceramic powder with a binder and forming a mixture into a sheet to obtain a green sheet; (C) forming an internal electrode pattern including a metal and sulfur on the green sheet; (D) stacking a predetermined number of green sheets on which internal electrode patterns are formed, disposing green sheets for cover layer on both ends in a stacking direction, and then pressure-bonding the green sheets to obtain a green multilayer body; (E) dividing the green multilayer body to obtain a pre-firing element body; (F) removing the binder from the pre-firing element body; (H) heating the pre-firing element body after removing the binder in a weakly reducing atmosphere in a temperature range of 800° C. or more and 1100° C. or less for 1 hour to 48 hours; and (I) firing the pre-firing element body after the heating to obtain a sintered body. The method further includes any one of (G) after the (F), applying an external electrode paste to a surface of the pre-firing element body after removing the binder, or (J) forming an external electrode on a surface of the sintered body after the (I).

### BRIEF DESCRIPTION OF THE DRAWINGS

FIG. 1 is a schematic view (a cross-sectional view in a longitudinal direction) illustrating the structure of a multilayer ceramic capacitor according to a first embodiment of the present disclosure.

FIG. 2 is a schematic view (a cross-sectional view in a width direction) illustrating the structure of the multilayer ceramic capacitor according to the first embodiment of the present disclosure.

FIG. 3 is a schematic view (a cross-sectional view in a longitudinal direction) illustrating the structure of a first modification of the multilayer ceramic capacitor according to a first aspect of the present disclosure.

FIG. 4 is a schematic view (a cross-sectional view in a longitudinal direction) illustrating the structure of a second modification of the multilayer ceramic capacitor according to the first aspect of the present disclosure.

FIG. 5 is a schematic view (an overall perspective view) illustrating the structure of a third modification of the multilayer ceramic capacitor according to the first aspect.

FIG. 6 is a diagram illustrating a Weibull plot generated based on the results of HALT for the multilayer ceramic capacitors according to examples of the present disclosure and comparative examples.

### DESCRIPTION OF EMBODIMENTS

When an internal electrode paste containing sulfur is used to reduce structural defects during the production of a multilayer ceramic capacitor, sulfur remains in a molded body after degreasing, and the sulfur burns during firing, thereby causing a problem of locally forming a reducing atmosphere. Specifically, the local reducing atmosphere causes the ceramic dielectric to become a semiconductor or promotes solid solution of the dielectric component to cause abnormal grain growth, thereby significantly reducing the reliability.

In Japanese Patent Application Publication No. 2017-25400, the relationship between the sulfur content in the internal electrode paste and the type and amount of gas generated when the temperature is raised is studied, but the sulfur content in the molded body after degreasing or the multilayer sintered body after firing is not studied.

An object of the present disclosure is to provide a multilayer ceramic electronic component having high reliability.

The present inventors have conducted various studies to solve the above-described problems, and found that the above-described object can be achieved by using an internal electrode paste containing metal particles and sulfur, optimizing the heat treatment conditions of a molded body, adjusting the generation start temperature of a sulfur compound during firing to 750° C. or higher, adjusting the temperature at which the generation amount reaches a peak to 750° C. or higher and 1000° C. or lower, and adjusting the generation end temperature to 1050° C. or lower, and setting the amount of sulfur in an element body constituting the obtained multilayer ceramic capacitor to a specific range when manufacturing a multilayer ceramic capacitor, thereby completing the multilayer ceramic capacitor according to the present disclosure.

Hereinafter, the configuration and the effects of the present disclosure will be described together with the technical idea with reference to the drawings. However, the action mechanism includes presumption, and the correctness or incorrectness thereof does not limit the present disclosure.

### First Embodiment

### [Multilayer Ceramic Electronic Component]

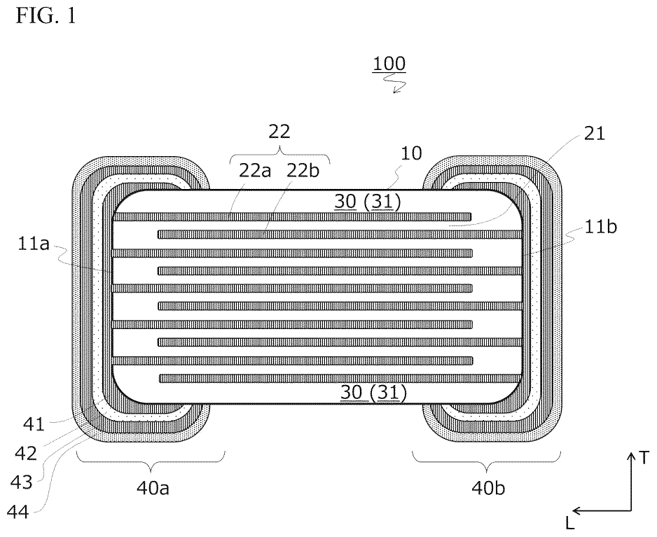

A multilayer ceramic capacitor, which is an embodiment of a multilayer ceramic electronic component according to a first aspect of the present disclosure, is illustrated in FIG. 1 as a first embodiment. A multilayer ceramic capacitor 100 according to the first embodiment preferably has a rectangular or substantially rectangular parallelepiped shape and includes three pairs of surfaces that are perpendicular to three axes perpendicular to each other, that is, an L axis in a length direction, a W axis in a width direction, and a T axis in a height direction, respectively. The rectangular parallelepiped is not limited to a rectangular parallelepiped defined mathematically, and may be a shape recognized as a rectangular parallelepiped when the entire shape is observed. Therefore, a rectangular parallelepiped having rounded ridges and corners, a curved ridge, and a curved surface with a small curvature is also included in the rectangular parallelepiped in the present disclosure. The dimensions of the multilayer ceramic capacitor 100 in the length (L) direction, the width (W) direction, and the height (T) direction may each independently be any value, and the magnitude relationship thereof is not limited. For example, (the dimension in the L direction)> (the dimension in the W direction)≥(the dimension in the T direction) may be satisfied, (the dimension in the W direction)> (the dimension in the L direction) may be satisfied, or (the dimension in the T direction)> (the dimension in the W direction) may be satisfied.

The size of the multilayer ceramic capacitor 100 is, for example, 0.25 mm for the L direction, 0.125 mm for the W direction, and 0.125 mm for the T direction, or 0.4 mm for the L direction, 0.2 mm for the W direction, and 0.2 mm for the T direction, or 0.6 mm for the L direction, 0.3 mm for the W direction, and 0.3 mm for the T direction, or 1.0 mm for the L direction, 0.5 mm for the W direction, and 0.5 mm for the T direction, or 3.2 mm for the L direction, 1.6 mm for the W direction, and 1.6 mm for the T direction, or 3.2 mm for the L direction, 2.5 mm for the W direction, and 2.5 mm for the T direction, or 4.5 mm for the L direction, 3.2 mm for the W direction, and 2.5 mm for the T direction. As the size of the multilayer ceramic capacitor 100 increases, the amount of internal electrodes 22 increases, and thus, defects such as structural defects due to the catalytic action of the metal as the main component thereof, and semiconductorization and abnormal grain growth of the ceramic layers due to sulfur added to suppress the catalytic action are likely to occur. Therefore, the effect of suppressing these defects by setting the sulfur content in an element body 10 within a specific range is remarkable in the large-sized multilayer ceramic capacitor 100. Specifically, the effect of suppressing the above problem becomes remarkable in a multilayer ceramic capacitor satisfying any one of a length of 3.2 mm or more, a width of 2.5 mm or more, and a height of 2.5 mm or more.

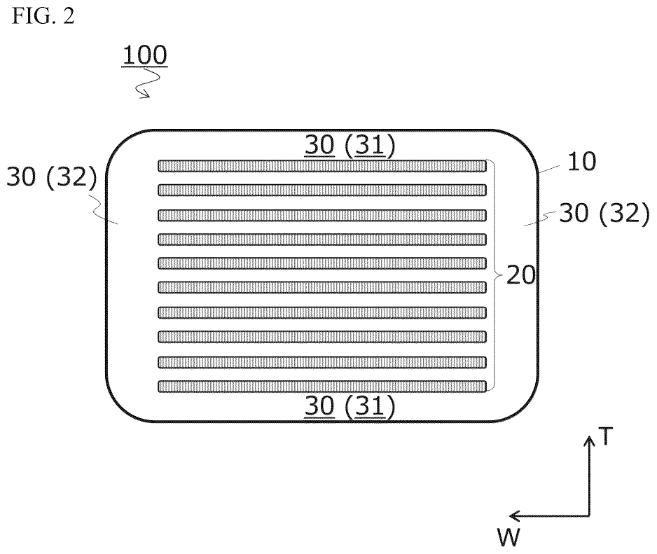

As illustrated in FIG. 1 (LT cross section) and FIG. 2 (WT cross section), the multilayer ceramic capacitor 100 according to the first embodiment includes the element body 10 including a multilayer body 20 in which dielectric layers 21 made of dielectric ceramics and the internal electrodes 22 made of a metal as a main component are alternately stacked in a T direction, and protective portions 30 covering surfaces of the multilayer body 20.

The element body 10 includes, on a surface parallel to the stacking direction (T direction), lead-out portions 11 (11a, 11b) in which the internal electrodes 22 (22a, 22b) are led out every other layer. That is, the element body 10 includes a lead-out portion 11a in which the internal electrodes 22a are led out in the L direction, and a lead-out portion 11b in which the internal electrodes 22b are led out in the L direction. In the multilayer ceramic capacitor 100 illustrated in FIG. 1, the pair of lead-out portions 11a and 11b are formed on substantially the entire regions of the surfaces of the element body 10 that are perpendicular to the L direction and face each other, but the arrangement of the lead-out portions in the multilayer ceramic capacitor according to the first aspect of the present disclosure is not limited thereto. The lead-out portion may be formed only in a part of a plane parallel to the stacking direction, may be formed only in one plane, or may be formed in a plurality of pairs. Furthermore, the lead-out portion may be not only a portion to which the internal electrodes are directly led out, but also a portion to which a connection conductor electrically connecting internal electrodes having the same polarity is led out as in a second modification described later.

The protective portions 30 are disposed on the surfaces of the element body 10 other than the lead-out portions so as to cover the surfaces of the multilayer body 20. The protective portion 30 includes a cover portion 31 disposed on a surface perpendicular to the T direction and a side margin portion 32 disposed on a surface perpendicular to the W direction.

The multilayer ceramic capacitor 100 according to the first embodiment includes external electrodes 40a and 40b that are disposed on the surfaces of the element body 10 and electrically connect the internal electrodes 22a to each other and the internal electrodes 22b to each other, the internal electrodes 22a and 22b being led out to the lead-out portions 11a and 11b, respectively.

Hereinafter, each component of the multilayer ceramic capacitor 100 according to the first embodiment will be described in detail.

### (Dielectric Layer)

The dielectric layer 21 is formed of a dielectric ceramic. The composition of the dielectric ceramic is not particularly limited as long as a dense dielectric ceramic is formed by co-firing with the internal electrode 22 described later, and may be appropriately selected according to the characteristics required for the multilayer ceramic capacitor. Examples of the composition of the dielectric ceramic include a composition containing barium titanate (BaTiO₃) as a main component, a composition containing strontium titanate (SrTiO₃) as a main component, and a composition containing Ba_{1-x-y}CaₓSr_{y}Ti_{1-z}Zr₂O₃ having a perovskite structure as a main component. The dielectric ceramic may contain an additive element together with the main component. Examples of the additive element include at least one selected from Mo, Nb, Ta, W, Mg, Mn, V, Cr, and rare earth elements (Y, Sm, Eu, Gd, Tb, Dy, Ho, Er, Tm, and Yb), and Co, Ni, Li, B, Na, K, and Si. The additive element may be contained as a simple substance of the element, or may be contained in the form of a compound such as an oxide, a nitride, or a carbide. The additive element may be present in a state of being solid-dissolved in the main component, or may form a hetero-phase with an element constituting the main component or another additive element.

The average particle diameter of the dielectric layer 21 is preferably 0.5 μm or less. When the average particle diameter is within the above range, the multilayer ceramic capacitor 100 has particularly high reliability. The average particle diameter is more preferably 0.3 μm or less.

Here, the average particle diameter of the dielectric layer 21 is determined by the following procedure. First, the multilayer ceramic capacitor 100 is cut along a plane parallel to the stacking direction passing through the vicinity of the center in the L direction, and a cut surface where the internal electrodes 22 (22a, 22b) are exposed is obtained. Next, the cut multilayer ceramic capacitor 100 is embedded in a resin such that the cut surface is exposed, and the resin is cured. Next, the cut surface exposed on the surface of the cured resin is mirror-polished. Next, carbon is vapor-deposited on the polished cut surface to impart conductivity, thereby obtaining a measurement sample. Next, the obtained measurement sample is observed using a scanning electron microscope (SEM) at a magnification at which about 60 to 200 dielectric particles are included in the field of view, and 4 to 6 photographs are taken for different observation locations. Next, the circle-equivalent diameter of each particle is calculated by image processing of the taken photograph. Next, from the obtained circle-equivalent diameter rᵢ of each particle and the number n of particles for which the circle-equivalent diameter rᵢ is calculated, the average particle diameter r_{avg} is calculated by the following Equation 1, and it is defined as the average particle diameter r_{avg} of the dielectric layer 21.

$${r}_{avg} = \frac{1}{n} {\sum }_{i = 1}^{n} ri \qquad [ Equation 1 ]$$

### (Internal Electrode)

The internal electrodes 22 (22a, 22b) are composed of a metal as a main component. The type of the metal is not particularly limited, and nickel (Ni), copper (Cu), palladium (Pd), platinum (Pt), silver (Ag), gold (Au), and alloys thereof can be used. Among these, a material containing nickel (Ni) as a main component element is preferable because the material can form the dense dielectric layer 21 by increasing a firing temperature due to its high heat resistance and is relatively inexpensive. Here, the “main component element” in the present specification means an element having the highest content expressed in atomic percentage (atom %). Each of the metals may cause rapid combustion of the binder by a catalytic action during firing in the production of the multilayer ceramic capacitor 100. However, the catalytic action of each of the metals can be suppressed by using sulfur in combination when forming the internal electrode pattern.

The internal electrodes 22 (22a, 22b) may contain, in addition to metals, dielectric particles having the same composition as the dielectric ceramic constituting the dielectric layers 21, and glass components.

### (Protective Portion)

The protective portion 30 includes the cover portion 31 disposed on a surface of the multilayer body 20 perpendicular to the T direction and the side margin portion 32 disposed on a surface perpendicular to the W direction, and has a function of protecting the dielectric layers 21 and the internal electrodes 22.

The material of the protective portion 30 is not limited as long as the material has high electrical insulation and low permeability to deterioration factors such as moisture. From the viewpoint of making shrinkage during firing uniform when the multilayer ceramic capacitor 100 is manufactured, relaxing internal stress in the multilayer ceramic capacitor 100, and the like, the main component of the protective portion 30 is preferably the same as that of the dielectric ceramic forming the dielectric layer 21.

### (Element Body)

In the element body 10 including the dielectric layers 21, the internal electrodes 22, and the protective portions 30, a sulfur concentration C_{S} in the element body 10 satisfies 0.12 ppm≤C_{S}≤14.5 ppm. The sulfur concentration C_{S} is obtained by dividing a sulfur amount obtained by analyzing, through a combustion-infrared absorption method, a gas generated in the course of heating a powdery sample obtained by grinding the element body 10 to 1250° C. by a mass of the powdered sample before heating. When the value of the sulfur concentration C_{S} is within the above range, the multilayer ceramic capacitor 100 has high reliability. This is presumed to be due to the following mechanism of action. The sulfur concentration C_{S} corresponds to the sulfur concentration in the element body 10. Therefore, the sulfur concentration C_{S} of 0.12 ppm or more indirectly indicates that a sufficient amount of sulfur content was contained to suppress rapid combustion of the binder due to the catalytic action of the metal as the main component of the internal electrodes during sintering in the production of the multilayer ceramic capacitor 100. Then, as a result of the action of sulfur, rapid combustion of the binder and shrinkage of the internal electrodes are suppressed, and thus the element body 10 has fewer structural defects, and the multilayer ceramic capacitor 100 has high reliability. On the other hand, the sulfur concentration C_{S} of 14.5 ppm or less indirectly indicates that, in the production of the multilayer ceramic capacitor 100, sulfurs contained during degreasing were sufficiently removed before sintering, and the generation of a local reduction atmosphere due to sulfurs was suppressed during sintering. As a result, the dielectric layer 21 is suppressed from being semiconductive and abnormal grain growth, and the multilayer ceramic capacitor 100 has high reliability. The term “sulfur” in the present disclosure means elemental sulfur unless otherwise specified. Therefore, when the element body or the internal electrode is described as “containing sulfur”, it means not only the case where the element body or the internal electrode contains sulfur alone but also the case where the element body or the internal electrode contains an organic or inorganic compound containing sulfur as a constituent element.

Here, the value of the sulfur concentration C_{S} is determined by the following procedure. First, the external electrodes 40 (40a, 40b) and the like present on the surfaces of the element body 10 of the multilayer ceramic capacitor 100 are shaved off with waterproof abrasive paper (#500) to obtain the element body 10. Next, the obtained element body 10 is ground using a mortar and a pestle to obtain a powdery sample. Next, the obtained powdery sample having a predetermined mass is heated to 1250° C. in a high frequency induction heating furnace, and the value obtained by dividing the amount of sulfur obtained by analyzing the generated gas by a combustion-infrared absorption method by the mass of the powdery sample before heating is defined as C_{S}.

The total amount of metal contained in the element body 10 is preferably equal to or more than 15 mg. In the element body 10 having a large content of metal, the catalytic action of the metal is large, and thus the rapid combustion of the binder during degreasing and the large shrinkage of the internal electrodes described above are likely to occur. In addition, the large metal content of the element body 10 is synonymous with the large size of the element body 10, and in the element body 10 having such a large size, when the internal electrode pattern containing sulfur is formed in order to suppress the catalytic action, sulfur is less likely to escape from the central portion during firing, and sulfur is likely to remain in the element body 10. Therefore, the conversion of the dielectric layer 21 into a semiconductor and abnormal grain growth due to sulfur in the element body 10 are also likely to occur. For these reasons, as described later, by setting the sulfur content of the element body 10 within a specific range, the effect of suppressing the structural defects and the defects such as the semiconductorization and the abnormal grain growth of the dielectric layer becomes more remarkable.

When the multilayer ceramic capacitor 100 is manufactured by an own company, the total amount of metal contained in the element body 10 can be calculated based on the formulation and the amount of the internal electrode paste used at the time of manufacturing. On the other hand, in the case of the multilayer ceramic capacitor 100 obtained as a finished product, the total amount of metal in the element body 10 is determined by the following procedure. First, a powdery sample is obtained in the same manner as in the above-described procedure for determining the sulfur concentration C_{S}. The powdery sample may be the same as that used for the determination of the sulfur concentration C_{S}. Next, the mass of the obtained powdery sample is measured and defined as the mass of the element body. The resulting powdered sample is then immersed in an acid solution to dissolve the metal. The type and concentration of the acid used at this time may be any type and concentration as long as the acid can dissolve the metals as the main component of the internal electrodes 22 (22a and 22b) without dissolving the dielectric layers 21 (dielectric ceramics) included in the element body 10. As an example, when the main component of the dielectric layer is barium titanate and the main component of the internal electrode is nickel, dilute nitric acid can be used. Next, the acid solution containing the powdery sample is filtered, and the solid content is washed and dried, and then the mass of the obtained solid content is measured and defined as the mass of the dielectric. Then, a value obtained by subtracting the dielectric mass from the element body mass is defined as the total amount of the metal contained in the element body 10.

### (External Electrode)

The external electrodes 40 (40a, 40b) are disposed on the surfaces of the element body 10 and are electrically connected to the internal electrodes 22 (22a, 22b) led out to the lead-out portions 11 (11a, 11b). In the multilayer ceramic capacitor according to the first aspect, as described above, the arrangement of the lead-out portions is not limited to that illustrated in FIG. 1, and therefore, it is needless to say that the arrangement of the external electrodes is not limited to this.

The materials of the external electrodes 40 (40a, 40b) are not limited as long as they have conductivity. Examples of the material include metals such as nickel (Ni), copper (Cu), tin (Sn), palladium (Pd), platinum (Pt), silver (Ag), and gold (Au), alloys containing any of these as a main component element, and conductive resins. The external electrode 40 (40a, 40b) may be formed by stacking a plurality of conductive materials on the surface of the lead-out portion 11 (11a, 11b). In the multilayer ceramic capacitor 100 according to the first embodiment illustrated in FIG. 1, the entire external electrode 40 has a multilayer structure in which a Cu layer 42, a Ni layer 43, and a Sn layer 44 are formed in the order from closest to farthest on the surface of a base layer 41 made of Ni.

### First Modification

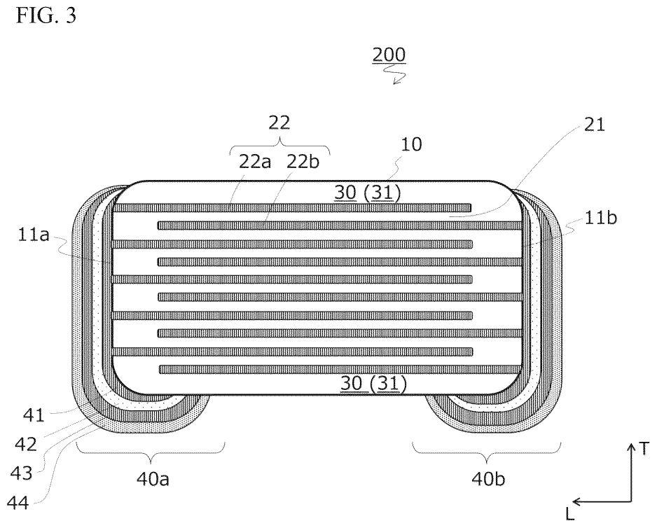

As a first modification of the multilayer ceramic capacitor according to the first embodiment, a multilayer ceramic capacitor 200 in which the external electrodes 40 (40a, 40b) are disposed on the surfaces of the element body 10 in an L shape in a cross-sectional view as illustrated in FIG. 3 is provided. The multilayer ceramic capacitor 200 having such a structure has an advantage that the height can be reduced because the external electrodes 40 do not extend around to the upper cover layer.

### Second Modification

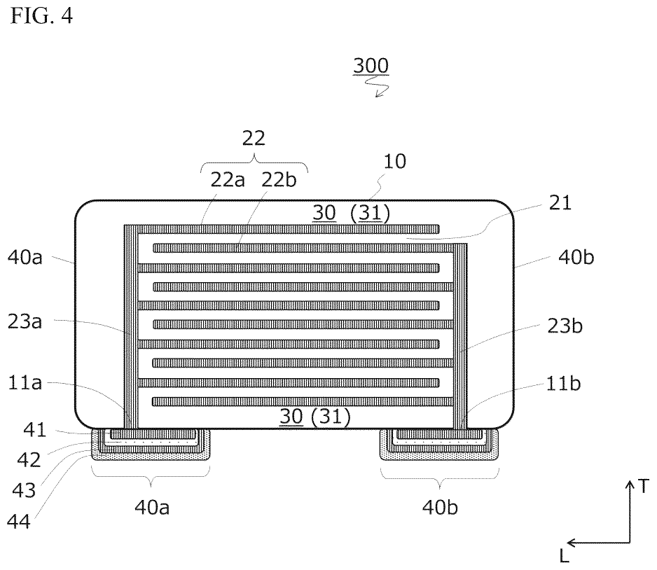

As a second modification of the multilayer ceramic capacitor according to the first embodiment, a multilayer ceramic capacitor 300 as illustrated in FIG. 4 is provided, in which connection conductors 23 (23a, 23b) that electrically connect the internal electrodes 22 (22a, 22b) of the same polarity formed inside the element body 10 are led out to one of the cover portions 31 to define the lead-out portions 11 (11a, 11b). The multilayer ceramic capacitor 300 having such a structure has an advantage that the size can be reduced because the external electrodes 40 (40a, 40b) are not present in the L direction and the W direction.

### Third Modification

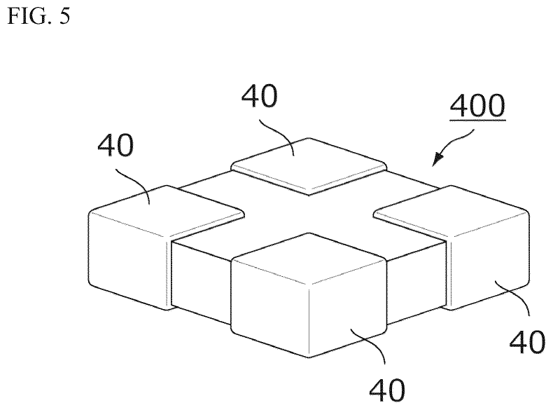

As a third modification of the multilayer ceramic capacitor according to the first embodiment, a multilayer ceramic capacitor 400 in which the external electrodes 40 are disposed at four locations as illustrated in FIG. 5 is provided. In the multilayer ceramic capacitor having such a structure, the effect of the present disclosure, that is, the improvement of reliability, can be obtained by setting the amount of sulfur contained in the element body within a specific range.

### Second Embodiment

### [Method for Manufacturing Multilayer Ceramic Electronic Component]

Next, a method for manufacturing a multilayer ceramic electronic component according to a second aspect of the present disclosure will be described below as a second embodiment, using an example of manufacturing the multilayer ceramic capacitor according to the first embodiment.

### ((A) Preparation of Dielectric Ceramic Composition Powder)

First, a powder of a dielectric ceramic composition is prepared. As the powder of the dielectric ceramic composition, commercially available powder can be appropriately used. In the case of self-producing the dielectric ceramic composition, various material powders containing the constituent elements thereof may be mixed at a predetermined ratio and preliminarily fired (pre-calcined). When mixing the various material powders at a predetermined ratio, various additives such as the above-described additive elements and sintering aids may be further added, and these various additives may be further added to the powder after the preliminary firing.

### ((B) Preparation of Green Sheet)

Next, the powder of the dielectric ceramic composition described above is mixed with a binder and a dispersion medium to prepare a slurry, and the slurry is formed into a sheet shape to obtain a green sheet.

As the binder, a binder which can maintain the shape of the green sheet and is volatilized without leaving carbon or the like by a binder removal treatment prior to firing is used. Examples of binders that can be used include those based on polyvinyl alcohol, polyvinyl butyral, cellulose, urethane, and vinyl acetate. The amount of the binder used is not particularly limited, but is preferably as small as possible within a range in which desired formability and shape retention are obtained, from the viewpoint of reducing the material cost, because the binder is removed in a subsequent step.

As the dispersion medium, a medium that does not cause aggregation of the preliminarily fired powder and the binder and can be easily removed by volatilization or the like after the green sheet formation described later is used. Examples of the dispersion medium that can be used include water and alcohol-based solvents.

Components for adjusting the properties of the slurry, such as a dispersant, a plasticizer, and a thickener, may be added to the slurry.

The method for mixing the mixed powder with the binder and the dispersion medium is not particularly limited as long as the components are uniformly mixed while preventing the mixing of impurities. One example is ball mill mixing.

As a method of molding the prepared slurry into a sheet shape to obtain a green sheet, a commonly used method such as a doctor blade method or a die coating method can be adopted.

### ((C) Formation of Internal Electrode Pattern)

Next, the formation of the internal electrode pattern containing the metal and sulfur on the green sheet may be performed by a method of printing or applying an internal electrode paste containing the above components on the green sheet in a predetermined pattern, or a method of forming a film containing the above components on the green sheet in a predetermined pattern by vapor deposition or sputtering. By making the internal electrode pattern contain sulfur, the catalytic action of the metal is suppressed, and the formation of structural defects due to rapid combustion of the binder at the time of binder removal described later can be suppressed.

When the internal electrode pattern is formed using the internal electrode paste, the internal electrode paste to be used is obtained by mixing metal particles, elemental sulfur or a sulfur-containing compound, and a vehicle with a three-roll mill. The internal electrode paste may contain glass frit or dielectric ceramic composition powder in addition to the above-described components.

The amount of sulfur in the internal electrode paste is preferably about 0.01 mass % or more and about 1.0 mass % or less, and more preferably about 0.05 mass % or more and about 0.5 mass % or less in terms of element with respect to the mass of the metal particles, for example, in order to effectively reduce the catalytic action of the metal and to reduce the conversion of the dielectric layer into a semiconductor.

The types and amounts of the binder and the solvent contained in the vehicle to be used are not limited, and may be appropriately selected in consideration of the viscosity of the internal electrode paste, the ease of handling, the compatibility with the green sheet, and the like.

The printing of the internal electrode paste on the green sheet can be performed using, for example, a screen mask on which a predetermined internal electrode pattern is formed. The printing may be performed with a space to be a side margin portion when the multilayer ceramic capacitor is formed.

### ((D) Preparation of Green Multilayer Body)

Next, a predetermined number of green sheets on which the internal electrode patterns are formed are laminated, and the green sheets are pressure-bonded to each other, thereby obtaining a green multilayer body. The stack and the pressure bonding may be performed by a commonly used method, and a method of pressing the stacked green sheets in the stacking direction while heating the sheets and performing thermocompression bonding by the action of the binder, or the like can be adopted.

In the stack and the pressure bonding, green sheets to be the cover portions when the multilayer ceramic capacitor is formed are added to both ends in the stacking direction. In this case, the additional green sheet may have the same composition as the green sheet on which the internal electrode pattern is printed, or may have a different composition. From the viewpoint of making the shrinkage rates at the time of firing uniform, the composition of the additional green sheet is preferably the same as or similar to the composition of the green sheet on which the internal electrode precursor is disposed.

### ((E) Preparation of Pre-Firing Element Body)

Next, the green multilayer body is divided into individual element bodies to obtain pre-firing element bodies. For the division, a commonly used means such as a dicing saw or a laser cutting machine can be adopted. After the green multilayer body is divided to form a surface on which the internal electrode precursor is exposed, the surface may be covered with a material for forming the side margin to form a pre-firing element body.

### ((F) Removal of Binder)

Next, the obtained pre-firing element body is heated to volatilize and remove the binder. The heating conditions may be appropriately set in consideration of the volatilization temperature and the content of the binder. For example, the temperature is maintained at 200° C. to 500° C. for 5 hours to 20 hours in a nitrogen gas (N₂) atmosphere.

### ((G) Adhesion of External Electrode Paste)

Next, as necessary, the external electrode paste is adhered to the surfaces of the pre-firing element body from which the binder has been removed so as to cover the lead-out portions. In the case where the external electrode paste is not adhered to the pre-firing element body at this stage, the external electrodes are formed by (J) described later.

The external electrode paste to be used is obtained by mixing metal particles and ceramic particles having the same composition as the dielectric ceramic composition contained in the pre-firing element body with a vehicle by a three roll mill. The external electrode paste may contain glass frit in addition to the above-described components.

The types and amounts of the binder and the solvent contained in the vehicle to be used are not limited, and may be appropriately selected in consideration of the viscosity of the external electrode paste, ease of handling, and the like.

Examples of a method of adhering the external electrode paste include immersing (dipping) a part of the pre-firing element body in an external electrode paste bath, and applying the external electrode paste to the surfaces of the pre-firing element body.

### ((H) Pre-Firing Heat Treatment)

Next, the pre-firing element body from which the binder has been removed and to which the external electrode paste has been adhered as necessary is subjected to a pre-firing heat treatment in a weakly reducing atmosphere in a temperature range of 800° C. or higher and 1100° C. or lower for 1 hour to 48 hours prior to firing. By such a pre-firing heat treatment in which the internal electrode pattern is held at a relatively high temperature for a long time in a weak reducing atmosphere, sulfur contained in the internal electrode pattern is volatilized and removed from the pre-firing element body, and the concentration thereof is sufficiently reduced. As a result, in the firing performed subsequently to the pre-firing heat treatment, the formation of a local reducing atmosphere due to the residual sulfur is suppressed.

Examples of the weakly reducing atmosphere applied to the pre-firing heat treatment include a nitrogen-hydrogen mixed atmosphere containing hydrogen (H₂) at a concentration of 0.01% by volume or more and 0.3% by volume or less, with the balance being nitrogen gas (N₂).

### ((I) Firing of Pre-Firing Element Body)

Next, the element body after the pre-firing heat treatment is fired by heating to a predetermined temperature. In setting the firing conditions, it is preferable to consider the sinterability of the dielectric ceramic composition, the heat resistance and oxidation resistance of the metal contained in the internal electrode paste, and the like. In addition, when the external electrode paste is adhered to the surface of the pre-firing element body prior to the firing, it is preferable to also consider the heat resistance and oxidation resistance of the metal contained in the paste. Examples of the firing conditions include holding the element body after the pre-firing heat treatment in a reducing atmosphere of a mixture of N₂, H₂, and H₂O at a temperature of 1100° C. to 1400° C. for 10 minutes to 2 hours. After the firing, a reoxidation treatment may be performed in which the element body is held at 600° C. to 1000° C. in a nitrogen gas (N₂) atmosphere or a low-oxygen atmosphere.

### ((J) Formation of External Electrode)

In the case where a sintered body obtained by firing does not have external electrodes without performing the above (G), external electrodes are formed on the surface of the sintered body. Examples of the method for forming the external electrodes include a method in which a conductor paste is adhered by printing, dipping, or coating and then baked, vapor deposition, and sputtering.

The sintered body obtained in this manner may be used as a multilayer ceramic capacitor as it is, or may be used as a multilayer ceramic capacitor after a conductive layer is formed on the surface of the external electrode by means of plating, vapor deposition, or the like. The multilayer ceramic capacitor obtained in this manner has the structure illustrated in FIG. 1 FIG. 3, or FIG. 5, and FIG. 2.

### First Modification of Second Embodiment

In the second embodiment, in order to form the connection conductor pattern inside the element body, through holes may be formed in the green sheet prior to the formation of the internal electrode pattern. As a method of forming the through holes in the green sheet, punching, laser processing, or the like can be adopted. By forming the internal electrode pattern on the green sheet having the through holes formed therein, or by filling the through holes with a conductor separately from the internal electrode pattern, the green sheet through which the conductors penetrate in the thickness direction is obtained.

When the green multilayer body is formed by stacking the green sheets through which conductors penetrate in the thickness direction, the conductors in the through holes are connected to each other in the stacking direction and are connected to the internal electrode patterns formed on the green sheets adjacent to each other in the stacking direction, thereby forming a precursor of a connection conductor. At this time, by forming a through hole filled with a conductor in one of the green sheets for the cover layer, a part of the precursor of the connection conductor is exposed on the surface of the cover layer.

### Second Modification of Second Embodiment

In the second embodiment, holes through which internal electrode patterns are led out may be formed in a wall surface in the thickness direction (stacking direction) of the green multilayer body obtained by stacking and pressure-bonding the green sheets, and the conductors may be filled in the holes to form the precursor of the connection conductor.

The multilayer ceramic capacitor obtained by each of the modifications of the second embodiment has the structure illustrated in FIG. 4.

### EXAMPLES

The present disclosure will be described in more detail with reference to the following examples, but the present disclosure is not limited to these examples.

### First Example

### (Preparation of Internal Electrode Paste)

As an internal electrode paste, a conductive paste containing nickel powder and 0.1 mass % of sulfur with respect to the nickel powder (hereinafter, simply referred to as an “internal electrode paste 1”) was prepared.

### (Preparation of Green Sheet)

As the powders of the dielectric ceramic composition, preliminarily-fired barium titanate (BaTiO₃) powders (average particle size: 0.2 μm) were prepared. Further, as a minor additive component, powders of oxides of Mn, Ho, Si, and the like were prepared. A polyvinyl butyral binder and an alcohol solvent were added to these powders, and the powders were mixed by a wet ball mill. The obtained mixed slurry was formed by the doctor blades to obtain the green sheet.

### (Production of Multilayer Ceramic Capacitor)

The internal electrode paste 1 was screen-printed on the obtained green sheet to form the electrode pattern, 600 layers of the green sheets were stacked, and 20 green sheets on which the internal electrode paste was not printed and which were to be cover portions were stacked on each of the upper and lower surfaces of the stacked green sheets, followed by thermocompression bonding to obtain a multilayer body. After the multilayer body was divided into individual pieces, the individual pieces were heated to 300° C. in a nitrogen atmosphere to perform a debinding process. The lead-out surfaces of the multilayer chip were immersed in a conductive paste containing nickel to form the precursors of the external electrodes. The multilayer body after the formation of the precursors of the external electrodes was subjected to the pre-firing heat treatment in which the multilayer body was held at 800° C. for 48 hours in a N₂—0.06 vol % H₂ atmosphere, which is the weakly reducing atmosphere, and then fired at 1200° C. for 2 hours in a so-called reducing-water vapor atmosphere in which water vapor was introduced into a reducing gas containing hydrogen in nitrogen gas, to obtain a multilayer ceramic capacitor according to a first example. The obtained multilayer ceramic capacitor had a rectangular shape in which a surface perpendicular to the stacking direction of the multilayer chip was 3.2 mm×2.5 mm, and the thickness of the dielectric layer was 2.5 μm. The total amount of nickel contained in the element body of the obtained multilayer ceramic capacitor was 17.4 mg.

### First Reference Example

In order to examine the influence of the amount of sulfur contained in the internal electrode pattern on the reliability of the multilayer ceramic capacitor, a multilayer ceramic capacitor according to a first reference example was obtained in the same manner as in the first example except that a conductive paste containing nickel powder and 0.2 mass % of sulfur relative to the nickel powder (hereinafter, simply referred to as “internal electrode paste 2”) was used as the internal electrode paste.

### Second Example

A multilayer ceramic capacitor according to a second example was obtained by the same method as that of the first example except that the temperature and the time of the pre-firing heat treatment were changed to 900° C. and 12 hours, respectively.

### First and Second Comparative Examples

A multilayer ceramic capacitor according to a first comparative example was obtained by the same method as that in the first example except that the temperature and the time of the pre-firing heat treatment were changed to 200° C. and 4 hours, respectively. A multilayer ceramic capacitor according to a second comparative example was obtained by the same method as that in the first example except that the temperature and the time of the pre-firing heat treatment were changed to 1100° C. and 6 hours, respectively.

### Third and Fourth Examples

A multilayer ceramic capacitor according to a third example was obtained in the same manner as in the first comparative example except that the number of green sheets on which the internal electrode paste 1 was printed was set to 155 layers in the production of the multilayer ceramic capacitor. The total amount of nickel contained in the element body of the multilayer ceramic capacitor according to the third example was 0.190 mg. A multilayer ceramic capacitor according to a fourth example was obtained in the same manner as in the second comparative example except that the number of green sheets on which the internal electrode paste 1 was printed was 1060 layers in the production of the multilayer ceramic capacitor. The total amount of nickel included in the element body of the multilayer ceramic capacitor according to the fourth example was 40.0 mg.

### [Evaluation of Multilayer Ceramic Capacitor]

### (C_{S} of Element Body)

For each of the multilayer ceramic capacitors according to the first to fourth examples, the first reference example, and the first and second comparative examples, the sulfur concentration C_{S} of the element body was determined by the method described above. The results are illustrated in Table 1.

### (Reliability)

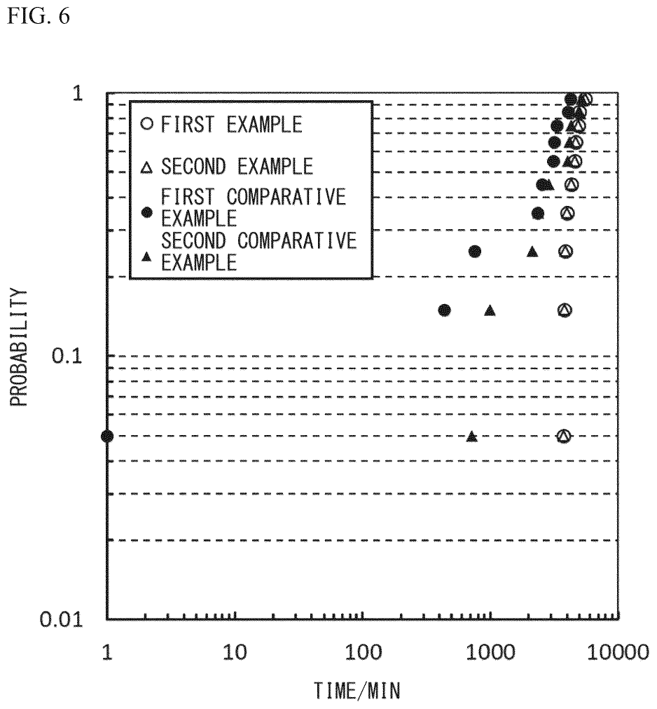

For each of the obtained multilayer ceramic capacitors (n=50), the time until failure was measured by a highly accelerated limit test (HALT). The measurement was performed by applying a DC electric field of 18 V/μm to each sample in a thermostatic chamber at 150° C. and measuring the time until the occurrence of a failure in which the leakage current became 10 times the minimum leakage current. A Weibull plot was drawn from the obtained measurement results, and a sample illustrating a single slope was determined to be acceptable, and a sample illustrating two or more slopes was determined to be unacceptable. The results are illustrated in Table 1. In addition, Weibull plots generated based on the measurement results of the multilayer ceramic capacitors according to the first and second examples and the first and second comparative examples are illustrated in FIG. 6.

TABLE 1

| | TOTAL | PRE-FIRING HEAT | | | |
|---|---|---|---|---|---|
| | AMOUNT OF | TREATMENT | | | |
| | NICKEL IN | CONDITION | | | |
| | ELEMENT | TEMPERA- | TIME | Cs | |
| | BODY [mg] | TURE [° C.] | [h] | [ppm] | HALT RESULT |
| FIRST | 17.4 | 800 | 48 | 14.5 | ACCEPTABLE |
| EXAMPLE | | | | | |
| FIRST | | | | — | ACCEPTABLE |
| REFERENCE | | | | | |
| EXAMPLE | | | | | |
| SECOND | | 900 | 12 | 0.12 | ACCEPTABLE |
| EXAMPLE | | | | | |
| FIRST | | 200 | 4 | 21.8 | UNACCEPTABLE |
| COMPARATIVE | | | | | |
| EXAMPLE | | | | | |
| SECOND | | 1100 | 6 | 0.06 | UNACCEPTABLE |
| COMPARATIVE | | | | | |
| EXAMPLE | | | | | |
| THIRD | 0.190 | 200 | 4 | 0.13 | ACCEPTABLE |
| EXAMPLE | | | | | |
| FOURTH | 40.0 | 1100 | 6 | 0.12 | ACCEPTABLE |
| EXAMPLE | | | | | |

“—” INDICATE NO MEASUREMENT

From the above results, it is found that the multilayer ceramic capacitors according to the first to fourth examples in which the sulfur concentration C_{S} in the element body including the ceramic layers, the internal electrodes, and the protective portions satisfies 0.12 ppm≤C_{S}≤14.5 ppm have high reliability. On the other hand, it is understood that the multilayer ceramic capacitors according to the first and the second comparative examples in which the value of the sulfur concentration C_{S} is out of the above-described range has low reliability. As a result of SEM observation for determining the average particle size, it was confirmed that cracks were present at the boundaries between the cover portions and the internal electrodes in the multilayer ceramic capacitor according to the second comparative example. From this fact, it is estimated that in the multilayer ceramic capacitor according to the second comparative example, as a result of excessive removal of sulfur by the pre-firing heat treatment, the amount of sulfur contained in the internal electrodes during firing extremely reduces, and the suppression of the catalytic action of nickel was insufficient.

In addition, since the multilayer ceramic capacitor according to the first reference example had excellent reliability as in the first example, it is estimated that even when the internal electrode pattern having a high sulfur content is formed, the sulfur concentration in the element body can be sufficiently reduced by performing the pre-firing heat treatment under predetermined conditions.

The present specification also discloses the following technique.

### Supplementary Note 1

A multilayer ceramic electronic component comprising:
an element body including:
   a multilayer body in which ceramic layers formed of ceramic and internal electrodes containing a metal as a main component are alternately stacked; and
   a ceramic protective portion covering a surface of the element body; and
an external electrode disposed on the surface of the element body and electrically connected to the internal electrodes;
wherein a sulfur concentration C_{S} in the element body satisfies 0.12 ppm≤C_{S}≤14.5 ppm, where the sulfur concentration C_{S} is obtained by dividing a sulfur amount obtained by analyzing, through a combustion-infrared absorption method, a gas generated in a process of heating a powdery sample obtained by grinding the element body to 1250° C. by a mass of the powdery sample before heating.

### Supplementary Note 2

The multilayer ceramic electronic device according to the Supplementary Note 1, wherein a total amount of the metal contained in the element body is equal to or more than 15 mg.

### Supplementary Note 3

A method of manufacturing a multilayer ceramic electronic component according to the Supplementary Note 1 or the Supplementary Note, the method comprising:
(A) preparing a ceramic powder;
(B) mixing the ceramic powder with a binder and forming a mixture into a sheet to obtain a green sheet;
(C) forming an internal electrode pattern including a metal and sulfur on the green sheet;
(D) stacking a predetermined number of green sheets on which internal electrode patterns are formed, disposing green sheets for cover layer on both ends in a stacking direction, and then pressure-bonding the green sheets to obtain a green multilayer body;
(E) dividing the green multilayer body to obtain a pre-firing element body;
(F) removing the binder from the pre-firing element body;
(H) heating the pre-firing element body after removing the binder in a weakly reducing atmosphere in a temperature range of 800° C. or more and 1100° C. or less for 1 hour to 48 hours; and
(I) firing the pre-firing element body after the heating to obtain a sintered body;
wherein the method further includes any one of
(G) after the (F), applying an external electrode paste to a surface of the pre-firing element body after removing the binder, or
(J) forming an external electrode on a surface of the sintered body after the (I).

### INDUSTRIAL APPLICABILITY

According to the present disclosure, a multilayer ceramic electronic component having high reliability can be provided. Such a multilayer ceramic electronic component is useful in that it can be applied to products requiring high reliability, such as automobiles and health and medical equipment.

The above embodiments are merely examples for carrying out the present disclosure, and the present disclosure is not limited to these embodiments. It is to be understood that the various change, substitutions, and alterations could be made hereto without departing from the spirit and scope of the invention.

What is claimed is:

1. A multilayer ceramic electronic component comprising:
an element body including:
a multilayer body in which ceramic layers formed of ceramic and internal electrodes containing a metal as a main component are alternately stacked; and
a ceramic protective portion covering a surface of the element body; and
an external electrode disposed on the surface of the element body and electrically connected to the internal electrodes;
wherein a sulfur concentration C_{S} in the element body satisfies 0.12 ppm≤C_{S}≤14.5 ppm, where the sulfur concentration C_{S} is obtained by dividing a sulfur amount obtained by analyzing, through a combustion-infrared absorption method, a gas generated in a process of heating a powdery sample obtained by grinding the element body to 1250° C. by a mass of the powdery sample before heating.

2. The multilayer ceramic electronic component according to claim 1, wherein
a total amount of the metal contained in the element body is equal to or more than 15 mg.

3. A method of manufacturing a multilayer ceramic electronic component according to claim 1, the method comprising:
(A) preparing a ceramic powder;
(B) mixing the ceramic powder with a binder and forming a mixture into a sheet to obtain a green sheet;
(C) forming an internal electrode pattern including a metal and sulfur on the green sheet;
(D) stacking a predetermined number of green sheets on which internal electrode patterns are formed, disposing green sheets for cover layer on both ends in a stacking direction, and then pressure-bonding the green sheets to obtain a green multilayer body;
(E) dividing the green multilayer body to obtain a pre-firing element body;
(F) removing the binder from the pre-firing element body;
(H) heating the pre-firing element body after removing the binder in a weakly reducing atmosphere in a temperature range of 800° C. or more and 1100° C. or less for 1 hour to 48 hours; and
(I) firing the pre-firing element body after the heating to obtain a sintered body;
wherein the method further includes any one of
(G) after the (F), applying an external electrode paste to a surface of the pre-firing element body after removing the binder, or
(J) forming an external electrode on a surface of the sintered body after the (I).
